(19) United States
(12) Patent Application Publication
(10) Pub. No.: US 2009/0033042 A1
(43) Pub. Date: Feb. 5, 2009

(54) Tool Chuck

(76) Inventor: James A. Rinner, Franksville, WI (US)

Correspondence Address: Arthur J. Hansmann, 222 White Sand Lane, Racine, WI, 53402, US

(21) Appl. No.: 12/224,155

(22) PCT Filed: Aug. 8, 2006
(86) PCT No.: PCT/US2006/030802

§ 371 Date: Aug. 18, 2008

(51) Int. Cl. B23B 5/22; B23B 31/16

(52) U.S. Cl. 279/72; 279/81; 279/46.1; 279/155

(57) ABSTRACT

A tool chuck (10) having a spring (58) for rotating a collar (13) to cam-lock a bit (11) into the chuck upon insertion of the bit into the chuck. Ball detents (32) and cams (57) serve to lock the bit into the chuck. A second spring (41) serves to eject the bit when so desired. There is a method for automatically locking the bit into the chuck, and there is indicia on the chuck for directing the user as to effecting the release of the bit.

This invention relates to a tool chuck, and, more particularly, it relates to a tool chuck that releasably locks the tool therein in response to only the action of inserting the tool into the chuck.

### BACKGROUND OF THE INVENTION

The prior art is already aware of tool chucks that releasably receive tools. Those chucks include arrangements wherein there are detent balls and cams which are operated by a movable collar on the chuck. Springs are included for influencing the movement of the collar.

The present invention improves upon the prior art in providing a chuck wherein only the insertion of the tool into the chuck is required to actuate the locking feature of the chuck. That is, only a single step, thus only one motion, is required for the locking. Further, the actual locking action is automatic and does not require further manual action from the assembler who inserts the tool for on-location use.

Further, only one motion applied by the user is all that is needed to release the tool from the chuck. Both the locking and that unlocking can be readily accomplished with the use of only one hand of the user. Both the tool locking and the tool release are automatic after a single action for each by the user, and it meets the precision for medical use.

Still further, the locked tool is not subject to being accidentally released, such as by forces applied during use, and release is only by rotation action applied by the user, so operating impact forces do not release. Permanent indicia directly on the chuck informs the user about the locking and releasing modes, so inadvertence is eliminated.

The tool is held in the chuck without shake, that is, without wobble, being radial digression, or without axial movement. In this accomplishment, the bit is in firm contact with the chuck body.

The method of arranging and effecting the locking and release of the tool are also included in this invention. There is one spring for locking the bit in the chuck and there is another spring for ejecting the bit.

### BRIEF DESCRIPTION OF THE DRAWINGS

FIG. 1 is an exploded perspective view of this tool chuck.

FIG. 2 is an exploded perspective of this tool chuck and with the tool bit added thereto.

FIG. 3 is a perspective view of a portion of FIG. 2.

FIG. 4 is a side elevation view of FIG. 3.

FIG. 5 is a side perspective view similar to FIG. 4 but rotated ninety degrees from FIG. 4.

FIGS. 6 and 7 are respectively right end elevation and left end elevation views of FIG. 5.

FIG. 8 is a section view taken on a plane designated by the line 8-8 of FIG. 5.

FIG. 9 is an enlarged perspective view of the right end of FIG. 4.

FIG. 10 is an assembled perspective view of a right end portion of FIG. 1.

FIG. 11 is a top plan view of FIG. 10.

FIGS. 12 and 13 are respectively front elevation and bottom plan views of FIG. 11.

FIG. 14 is a section view taken on a plane designated by the line 14-14 of FIG. 11.

FIGS. 15, 16, and 17 are section views taken respectively on planes designated by the lines 15-15, 16-16, and 17-17 of FIG. 11.

FIG. 18 is a perspective view of a portion of FIG. 10.

FIG. 19 is a top plan view of FIG. 18.

FIG. 20 is a section view taken on a plane designated by the line 20-20 of FIG. 19.

FIG. 21 is a front elevation view of FIG. 19.

FIG. 22 is a right side elevation of FIG. 21.

FIG. 23 is a perspective view of a portion of FIG. 10.

FIG. 24 is a top plan view of FIG. 23.

FIG. 25 is a section view taken on the plane designated by the line 25-25 of FIG. 24.

FIG. 26 is a front elevation view of FIG. 24.

FIG. 27 is a right side elevation view of FIG. 26.

FIG. 28 is an enlarged front elevation view of a portion of FIG. 2.

FIG. 29 is a section view taken on a plane designated by the line 29-29 of FIG. 28.

FIG. 30 is a front elevation view like FIG. 28 but with a slightly rotated position of a portion thereof.

FIG. 31 is a left side elevation view of FIG. 30.

FIG. 32 is a section view taken on a plane designated by the line 32-32 of FIG. 30.

FIG. 33 is a section view taken on the two planes designated by the angular line 33-33 of FIG. 31.

FIG. 34 is a top plan view of a portion of FIG. 2.

FIG. 35 is a section view taken on a plane designated by the line 35-35 of FIG. 34.

FIG. 36 is a top plan view of a portion of FIG. 2 but showing the tool bit in assembled but unlocked position.

FIG. 37 is a section view taken on a plane designated by the line 37-37 of FIG. 36.

FIG. 38 is a top plan view of FIG. 2 but with the tool bit in its locked position.

FIG. 39 is a section view taken on a plane designated by the line 39-39 of FIG. 38.

FIG. 40 is a top plan view like FIG. 36 but indicating the tool release mode.

FIG. 41 is a section view taken on a plane designated by the line 41-41- of FIG. 40.

FIG. 42 is an enlarged section view like FIG. 39 showing the tool bit locked in and with the view being rotated from FIG. 39.

FIG. 43 is an enlarged section view like FIG. 41 showing the tool bit released and with the view being rotated from FIG. 41.

FIG. 44 is a view similar to FIG. 13 but enlarged and showing a sectioned part and the tool bit added thereto and a slightly rotated position from FIG. 13.

FIG. 45 is an enlarged section view taken on a plane designated by the line 45-45 of FIG. 6.

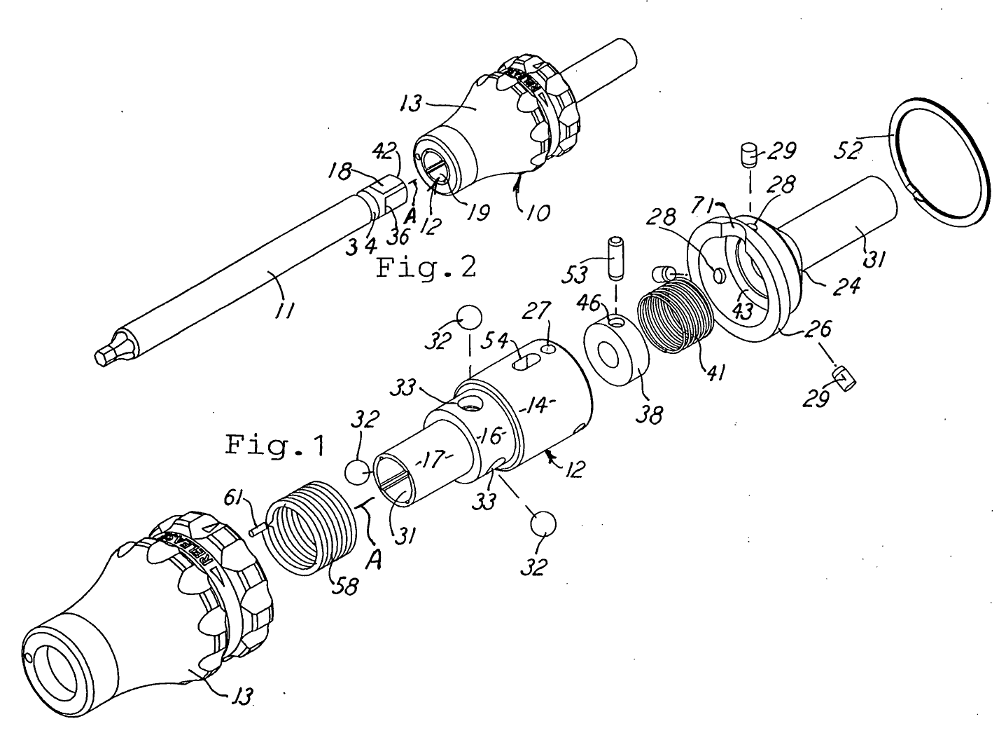

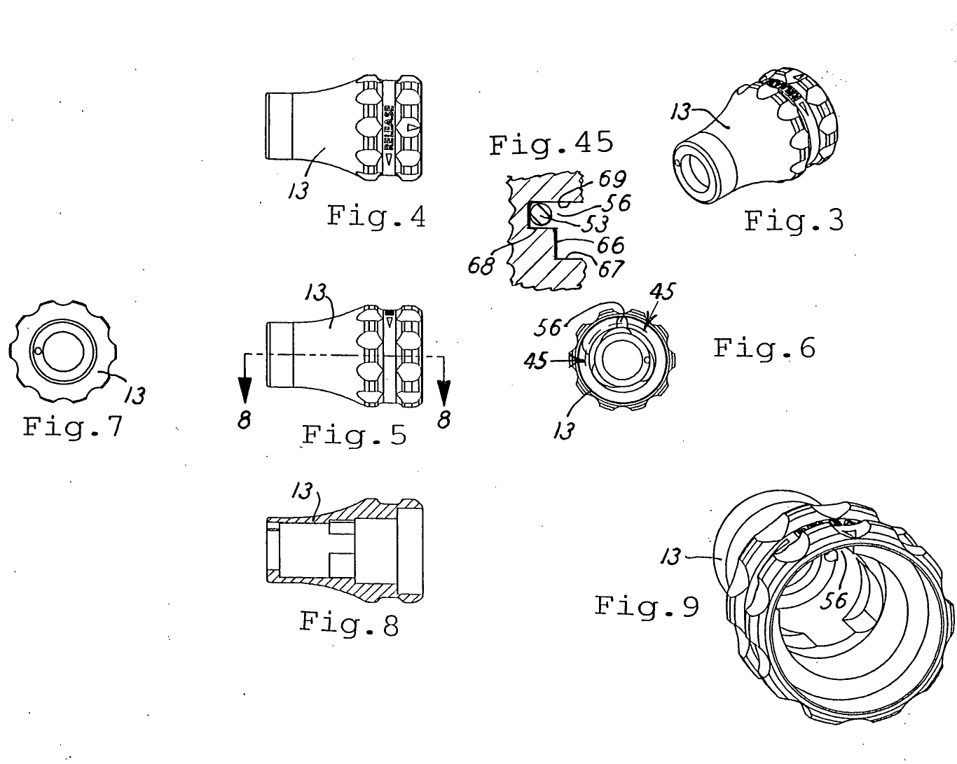

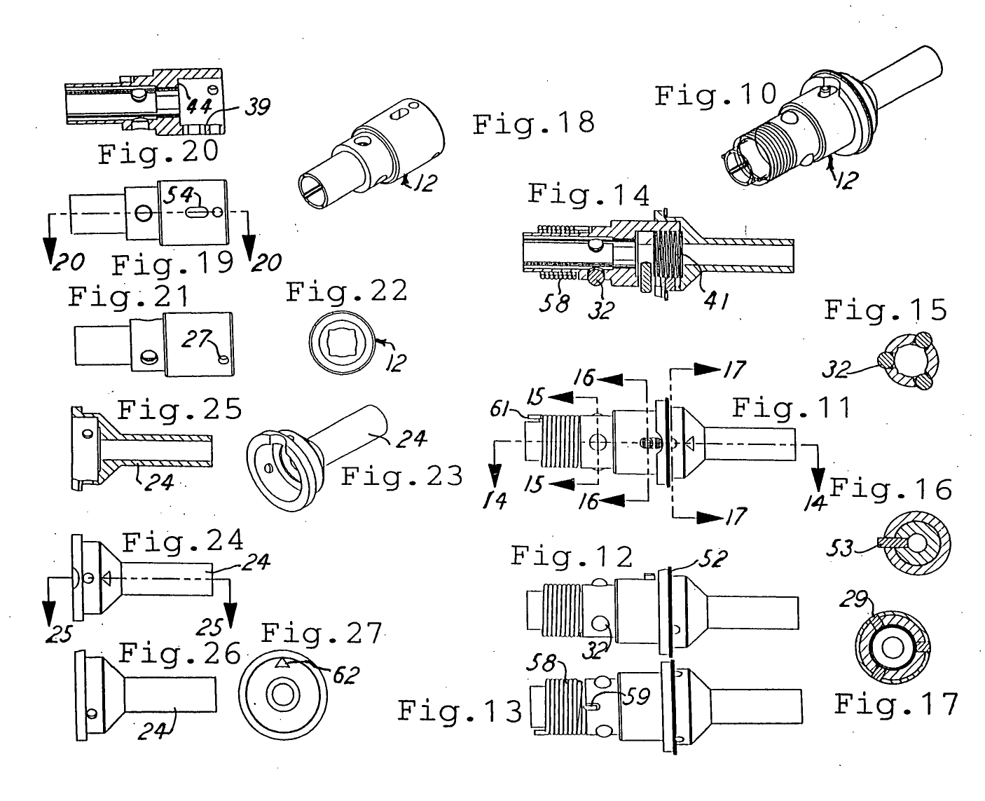

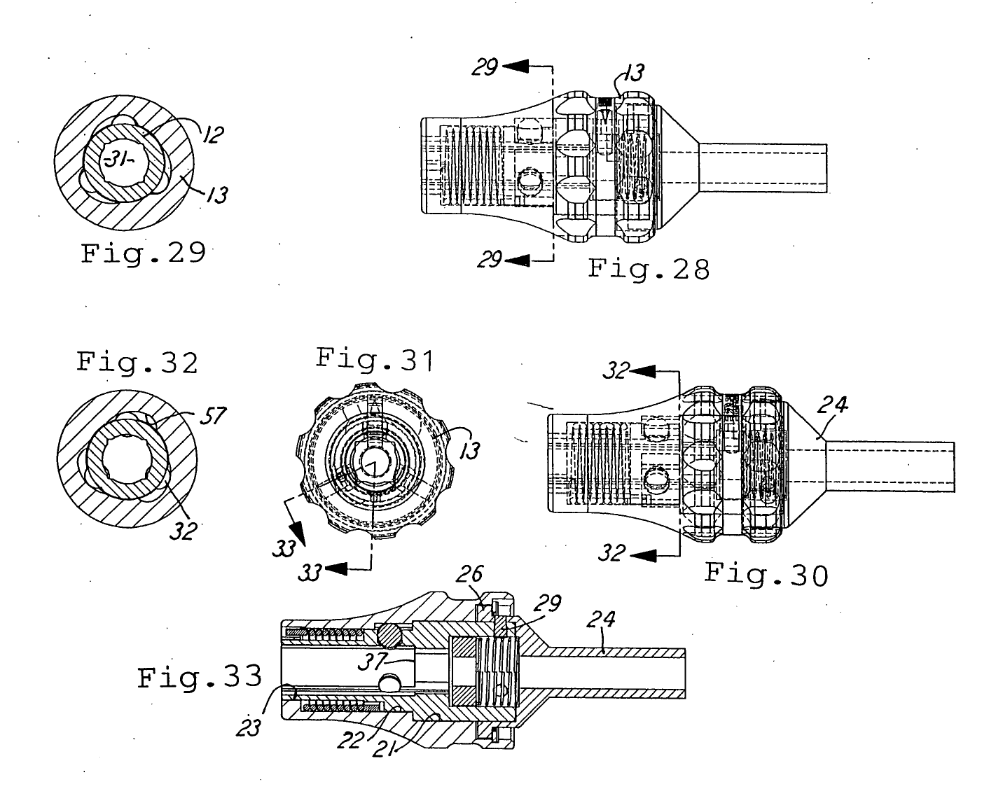

### DETAILED DESCRIPTION OF THE PREFERRED EMBODIMENT AND METHOD

The drawings show an embodiment which has a tool chuck 10 for receiving and rotationally driving a tool bit 11. There is a body 12 and a collar 13 rotatable on the body 12 and about a longitudinal axis A. It will be understood that the chuck 10 can be rotated by any conventional driver which is not, and need not be, shown herein. As such, this chuck can be an adapter interposed between the bit 11 and the unshown driver.

The body 12 is shown to be cylindrical along the axis A and in three stepped sections 14, 16, and 17, and they all have an axial opening therethrough for reception of other parts shown, including the bit 11 which has a rotation drive end 18 rotationally mateable with the body driver end 19, in a conventional manner. The bit 11 can be slid into and out of the body end 19 along the axis A.

The collar 13 is cylindrical along the axis A, and it can have three interior cylindrical surfaces 21, 22, and 23 for respective rotational piloting on the body 12 at the three body cylinders 14, 16, and 17, such as seen in FIG. 33. A stem 24, shown in funnel shape, is also on the axis A and has a circular flange 26 extending over the body 12 and thus the stem 24 is considered to be a part of the body. The body 12 and the stem part 24 have aligned respective holes 27 and 28 which receive assembly pins 29 for rotationally and axially affixing the stem 24 on and as part of the body 12. A cylindrical end 30 on the stem can be arranged to conventionally rotationally attach to the unshown driver.

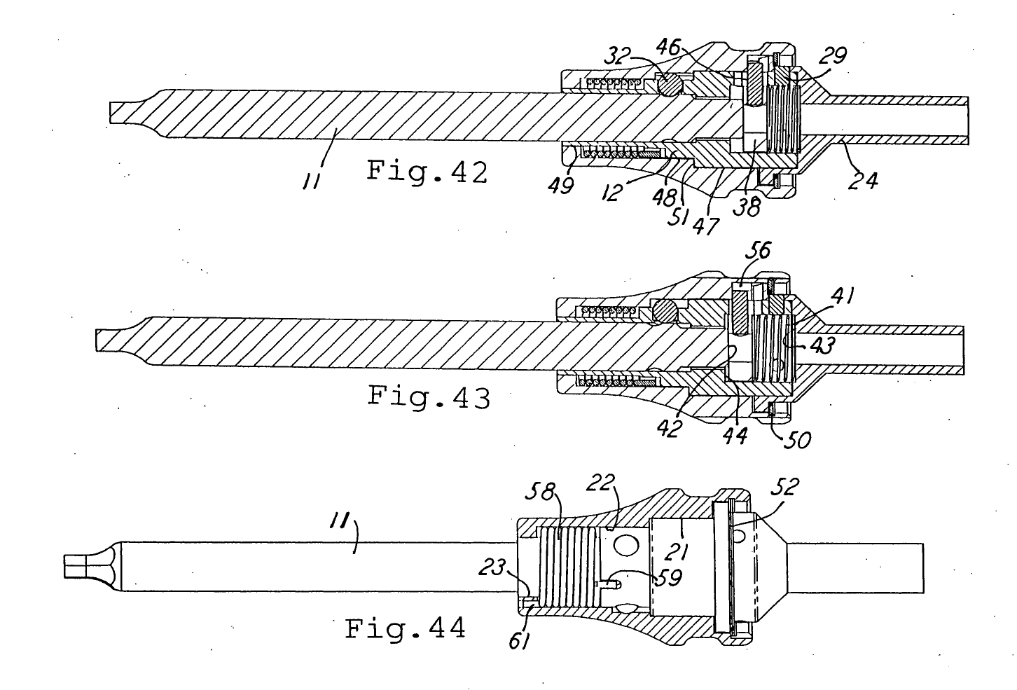

The bit 11 can be inserted into the chuck by sliding thereinto along the axis A at an axial opening 31 at the body end 19. It is that insertion that automatically secures the bit in the chuck in the axial and rotational set relationship without any further action by the user. In that insertion, there are three balls 32, as detents, and carried by and supported in three holes 33 on the body 12, which engage a groove 34 in the bit to axially and radially hold the bit in the chuck. Also, the bit has a bevel surface 36 which abuts a circular edge 37, in FIGS. 33 and 42, on the body 12. Thus, the bit is secured against movement in that it is held radially inwardly by the body 12 on those two surfaces 34 and 36.

Also, there is a ring member 38 in a FIG. 20 circular opening 39 in the body 12, and the member 38 can move axially in the body 12. A compression spring 41, also in the opening 39, urges the member leftward, as viewed, and against the bit end wall 42. The aforementioned parts are dimensioned and related such that insertion of the bit causes it to force against the member 38 and compress the spring 41, such as in the FIG. 42 mode. Spring 41 is restrained axially by a wall 43 in the fixed stem 24. Also, member 38 is limited in leftward axial movement by a wall 44 in the body 12, so there can be built-in pre-compression on the spring 41 to have the member 38 force against the bit 11, as desired.

The cylindrical collar 13 is axially fixedly but rotationally mounted on the body. Thus the collar and the body have rotational mating circular surfaces at 47, 48, and 49, as in FIG. 42. Circular mating axially abutting surfaces at 51 on the body and the collar restrict the collar in the rightward axial direction, and an assembly retainer ring 52 abutting the shown collar groove 50 and the stem 24 restricts the collar in both axial directions on the body 12.

To control the rotation of the collar 13 on the body 12, the member 38 has a radially extending control in the form of a pin 53 snug in a hole 46, and the pin 53 engages the body 12 in a slot 54 in the body. The collar 13 has a slot 56 which receives the radial end of the pin 53 to thereby preclude rotation of the collar on the body when the pin 53 is thus engaged with the collar. So the body 12 and the collar 13 have aligned respective slots 54 and 56 which receive the pin 53 and thereby preclude rotation of the collar when in that mode. When the member 38 is moved axially by the insertion of the bit 11, the pin 53 is moved out of the collar slot 56 and the collar is then free to rotate on the body 12. In that rotation, the collar has cam surfaces 57 which force down on the three balls 32 and position them in the bit groove 34 for locking the bit, per FIGS. 29 and 32 respectively showing released and locked positions. The amount of rotation need not be more than the circular extent of each cam surface 57, and those cams 57 limit the amount of collar rotation when the bit is fully in the locked mode. So the insertion will displace the member 38 an axial distance sufficient to effect the removal of the pin 53 from the collar slot 56.

A torsion spring 58 is piloted on the body 12 and has two axially extending ends 59 and 61 respectively connected with the body and the collar in recesses therein and those ends serve as spring rotation anchors, such as seen in FIG. 44. Spring 58 has pre-set torsion tension so it will rotate the collar in the direction mentioned to effect the camming action described when the collar is released to rotate as mentioned. That locks the bit 11 into the chuck and does so with only the one action of inserting the bit into the chuck.

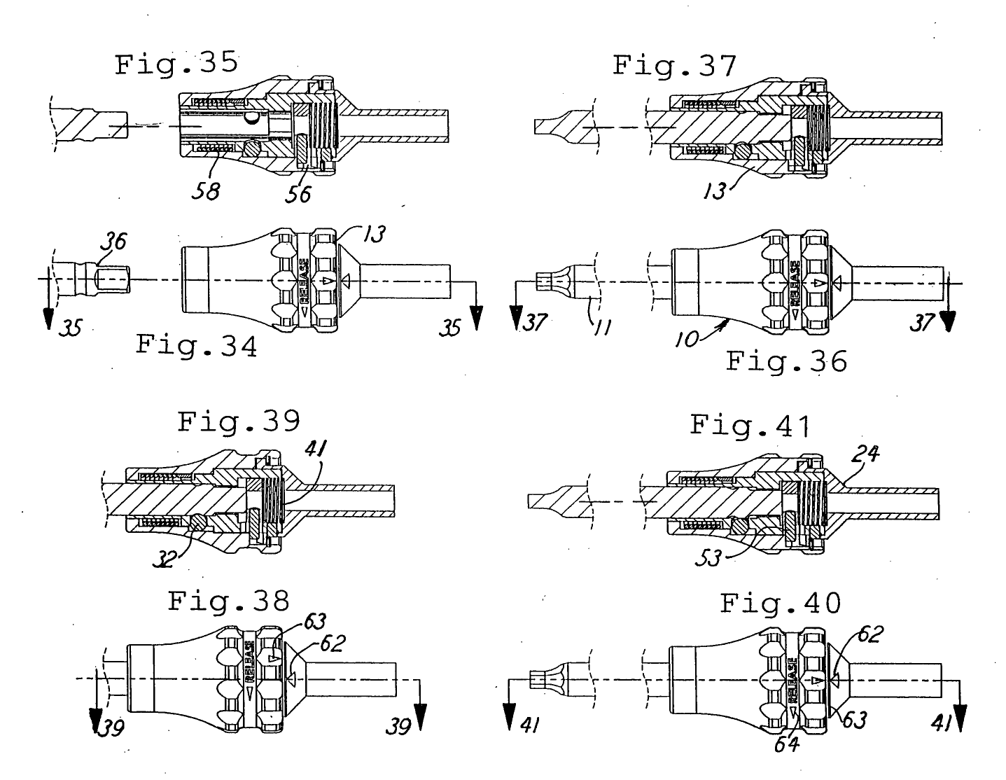

To release the bit, as seen in FIG. 40, the user can rotate the collar back to its starting position and against the force of the spring 58. For that, there is indicia on the chuck, such as the arrows 62 and 63 respectively on the stem and the collar. Aligning those arrows by rotating the collar in the direction of the RELEASE arrow 64 will reposition the pin 53 back into the collar slot 56 and release the cams and have the spring 41 automatically urge the bit 11 out of the chuck. FIGS. 34 through 41 show the sequential modes from inserting the bit to the release of the bit.

FIGS. 6 and 45 show the collar slot 56 with the pin 53 therein awaiting insertion of the bit 11. Upon insertion, the pin 53 is moved rightwardly to clear the slot 56 by moving beyond the plane of a ledge 66 on the collar. The torsion spring 58 then itself rotates the collar to have a collar surface 67 move toward the pin 53 and thereby have the cams 57 rotate onto the detents 32, and that is when the bit 11 is locked in the chuck. So the collar walls 67 and 68 are spaced apart a distance sufficient to have the collar rotate to that locking mode, as in FIGS. 38 and 39, with the unaligned arrows showing the user that the bit is locked. To return to the bit release mode, the collar is rotated by the user in the direction of the RELEASE arrow to align the arrows, as in FIG. 40. In that release action, the collar is rotated to have the collar surface 67 move away from the pin 53 to thereby present the abutment surface 69 to the pin 53 and thus serve as a stop for collar rotation and have the pin 53 move axially in the slot 56 and thereby assume the positional relationship with the collar as seen in FIG. 45. So the collar can rotate only, and the pin 53 can move only axially, and the respective movements create the operation shown with FIGS. 29 and 32.

The stem flange 26 presents a pocket 71 for receiving the pin 53 when the pin is axially moved in the bit locked mode for firmly axially setting in the bit locked position. In preference, the axial length from the bit groove 34 to the bit end 36 which contacts the body circular abutment 37, is arranged to have the balls 32 be received in the bit groove in the fully inserted mode, such as seen in FIG. 42. Additionally, the axial urging of the spring 41 on the member 38, as in FIG. 42, can urge the bit 11 into snug camming action of the balls 32 into the bit groove 34, so the bit becomes trapped and it still can have axial limit with the body abutment circle 37.

The foregoing describes both the apparatus and the method for locking and releasing the bit 11. Insertion of the bit into the body parts automatically locks the bit, and simply rotating the collar 13 to the RELEASE mode ejects the bit. So spring 58 serves to lock, and spring 41 serves to secure and also eject.

What is claimed is:

1. In a tool chuck (10) having body (12) with a longitudinal axis (A) and an opening (31) extending along said axis for releasably receiving a tool (11) movable into said opening along said axis, a collar (13) is movable on said body and relative to said axis and has cam means (57) thereon, a first spring (41) is in said body for urging relative to said tool in said opening and in the axial direction, a second spring (58) is effective between said body and said collar for effecting movement of said collar relative to said body, tool restraining detents (32) are on said body cooperative with said cam means and with the configuration of said tool for releasably holding said detents against said tool for locking said tool in said chuck in response to movement of said collar, the improvement comprising:
said springs (41, 58) being arranged to be individually and sequentially operative and said with first spring (41) being in operative relationship with said tool (11) upon insertion of said tool into said opening (31) for firstly holding said cam means (57) in the tool unlocked mode and for effecting subsequent release of said tool, and
said second spring (58) being operative on said collar (13) for secondly setting said cam means into locking relationship with said detents (32) for the locking of said tool in said chuck.

2. The tool chuck as claimed in claim 1, further comprising:
said cam means on said collar is arranged for locking with said detents by rotation of said collar on said body, and
said second spring is a torsion spring connected with said collar for rotation of said collar in effecting the tool locking.

3. The tool chuck as claimed in claim 2, further comprising:
said collar being reversibly rotatable against the urging of said second spring for release of said detents relative to said tool, and
said first spring and said tool being arranged for urging said tool out of said opening upon reverse rotation of said collar.

4. The tool chuck as claimed in claim 2, further comprising:
said tool having two axially spaced-apart radially facing surfaces (34, 36) for simultaneous respective direct contact with said detents and said body for stability of said tool in said chuck.

5. The tool chuck as claimed in claim 4, further comprising:
said first spring (41) yieldingly urges on said tool for subsequent contact of said tool with said detent and said body.

6. The tool chuck as claimed in claim 1, further comprising:
a member (38) movable in said opening and urged by said first spring into a first position and being connectable with said collar in said first position for restraining movement of said collar, and
said tool being operative on said member for movement of said member to a second position for release of said collar.

7. The tool chuck as claimed in claim 6, further comprising:
said member (38) and said collar (13) having an axial operative pin and slot (53, 54) connection therebetween for rotation restriction of said collar and for release of said collar upon axial movement of said member, and
said first spring being arranged to urge said pin and slot into operative relationship with each other.

8. In a tool chuck (10) having body (12) with a longitudinal axis (A) and an opening (31) extending along said axis for releasably receiving a tool (11) movable into said opening along said axis, a collar (13) movable on said body and relative to said axis and having cam means (57) thereon, tool restraining detents (32) on said body cooperative with said cam means and with the configuration of said tool for releasably holding said detents against said tool for locking said tool in said chuck in response to movement of said collar, the improvement comprising:
two springs (41, 58) in said body for urging relative to said collar and said tool in said opening and for urging respectively in the axial and rotational directions whereby axial urging releases said collar for rotational movement effective for locking said detents onto said tool.

9. The tool chuck as claimed in claim 8, further comprising:
a first one (41) of said springs effective between said body and said collar effective for the axial movement, and
a second one (58) of said springs operative on said collar for secondly setting said cam means into locking relationship with said detents for the locking of said tool in said chuck.

10. The tool chuck as claimed in claim 9, further comprising:
said first spring being in the path of insertion of said tool in said opening for operating said first spring in response to inserting said tool, and
said second spring being arranged to exert cam means and detent locking rotation to said collar after insertion of said tool.

11. A method of releasably locking a tool (11) in a chuck (10) having a body (12) and a collar (13) and detents (32) which are mutually cam-operative to lock said tool in the chuck, the improvement comprising:
inserting the tool into the chuck and thereby displacing a member (38) which is releasably restraining said collar and thereby release said collar, and
applying a spring (58) against said collar for rotating said collar in response to the force from said spring and thereby effect the cam-operative locking of said tool in the chuck.

12. The method of locking as claimed in claim 11, further comprising:
arranging said member in said body for axial movement of said member in response to the insertion of said tool, and
arranging said spring to be a torsion spring effective on said collar for the cam-operative locking.

13. The method of locking as claimed in claim 12, further comprising:
rotating said collar against the urging of said spring for releasing said tool.

14. The method of locking as claimed in claim 12, further comprising:
applying an additional spring (41) against said member for countering the forcing on said tool against the insertion of said tool into said chuck.

15. In a tool chuck (10) having body (12) with a longitudinal axis (A) and an opening (31) extending along said axis for releasably receiving a tool (11) movable into said opening along said axis, a collar (13) movable on said body and relative to said axis and having cam means (57) thereon, a tool restraining detent (32) on said body cooperative with said cam means and with said tool for releasably holding said detent against said tool for locking said tool in said chuck in response to movement of said collar, the improvement comprising:
a spring (58) in said body and being forceful on said collar for urging said collar relative to said body and said tool in said opening for locking said detent onto said tool, and
a control (38) operative relative to said spring for restraining said spring and being in said opening for displacement by said tool being inserted into said opening and for thereby releasing the restraint on said spring and thereby having said spring force on said collar for the locking by said detent.

16. The tool chuck as claimed in claim 15, further comprising:
said spring being a torsion spring (58) for rotation of said collar upon release of said spring for the locking by said detent.

17. The tool chuck as claimed in claim 16, further comprising:
an additional spring (41) in said body in the path of insertion of said tool into said opening and being forceful against the insertion of said tool into said body and said control being operative on said additional spring in response to inserting said tool and for holding said additional spring free of ejecting said tool, and
said control and said collar having spring restraint means (53, 66) operative on said additional spring for holding said additional spring ineffective relative to said tool when said tool is injected into said opening and with said restraint means being releasable for the ejection of said tool by said additional spring.
